(19) United States
(12) Patent Application Publication
(10) Pub. No.: US 2003/0139837 A1
(43) Pub. Date: Jul. 24, 2003

(54) System and method for monitoring a control process in a process plant

(76) Inventor: Edmund John Marr, Chippenham Wiltshire (GB)

Correspondence Address: David L McCombs, Haynes & Boone, Suite 3100, 901 Main Street, Dallas, TX, 75202, US

(21) Appl. No.: 10/204,129

(22) PCT Filed: Feb. 19, 2001
(86) PCT No.: PCT/GB01/00698

(30) Foreign Application Priority Data
Feb. 22, 2000 (GB) 0004194.7

(51) Int. Cl. G06F 19/00

(52) U.S. Cl. 700/110; 700/108

(57) ABSTRACT

A System and a method are provided for the monitoring of a control process in a process plant such as a power generation plant. The process plant contains a plurality of plant items to be controlled, such as valves, pumps, turbines and so forth. At least some of these have sensors attached to them which output a digital (binary) or analog signal indicative of the status of that plant item. Many plant items also have control actuators for shutting and opening the valve, for example. The plant item sensor outputs are connected to a network and a control algorithm representing the control logic of the process plant processes the sensor outputs.

The output of one of a plurality of control functions forming the control algorithm is selected to begin a fault tracing procedure. The control logic forming the control algorithm is visually displayed on a computer monitor. The selected control function output is traced back to its source via the control algorithm shown on the computer monitor to identify the root cause of a fault.

### FIELD OF THE INVENTION

This invention relates to a method and a system for monitoring a control process in a process plant such as a power station or a paper mill. The invention is particularly concerned with fault diagnosis therein.

### BACKGROUND OF THE INVENTION

Modern process plants often consist of a large array of plant items, each typically having an electronic sensor indicative of the state or process value of the plant item to which it is connected. Control of the plant items via actuators, for example, is possible remotely, from a central console, or automatically. The plant sensors may output a binary (true or false) voltage, for example, when connected to a valve, or an analogue current indicative of motor speed, for example. The various signals are input to signal conversion equipment to transform them into computer readable data, and then connected onto a network so as to form a so-called distributed control system (DCS), under processor control. Subsystems are also often connected into the DCS. These tend to be proprietary, self-contained units such as water treatment plants which have a single serial data output connection to the DCS.

Originally, the process plant control personnel were provided with a large display “map” containing lights to display the binary state of binary devices, and analogue dials to monitor the state of analogue plant items. Typically, the map was laid out schematically to represent the piping and instrument connections around the process plant. With the advent of solid state electronics, the DCS is now linked to custom-built consoles with visual display units that mimic the piping and instrument connection map previously employed. As such, a real time indication of the status of the various sensors around the plant may be obtained, and control of the associated plant item may be carried out remotely by the operator.

An important function of the DCS is to allow computer-controlled shut-down and start-up of areas of the process plant. Usually, this requires a complex sequence of events to be carried out on successive items of plant. For example, to start a turbine in a power station, a series of checks on various valve states, water temperature and pressure, and so forth must be carried out, and the next step in the sequence may not be commenced until the binary state or analogue value of each item is deemed correct.

Usually, there is an interlock so that, for example, the turbine fans may not be started if a particular valve is not open.

It will be appreciated that there are often a significant number of process steps to be carried out in a start-up or shut-down sequence, each of which depends in turn on a large number of plant items being in a correct state and, of course, functioning properly. Most commercially available DCS are able only to display to the control personnel the state of each component as it is at that time. In particular, there is no functional indication of the relationship between plant items in terms of control and protection logic (protection logic defines whether a switch or the like is locked in an ‘on’ or ‘off’ position).

Typically, the control personnel will discover that they are unable to start a plant item (such as a turbine in an electricity generation station), or they will receive an alarm indicating that an automatic operation has failed. They must then examine the DCS display to determine the general state of the plant area and the detailed control panel for the item. This may inform them that a release signal for the item in question (such as a valve) has not been asserted, but with the present arrangement they generally have no idea how that release signal is derived, and hence what the root cause of the problem is. Often, the root cause of the problem is a combination of control and protection logic, current plant state, and plant trend and event history.

Mostly, fault diagnosis is carried out by reverting to paper-based engineering drawings and attempting to trace backwards along the logic paths to try and find the fault. It is often then extremely difficult and time-consuming to ascertain the cause of the fault. Such tracing is also prone to errors. Some recent systems have attempted to include the engineering control logic drawings along with the mimicked piping and instrument connection maps on the visual display units, but the only benefit of this is that the control personnel no longer need to sift through many pages of paper-based engineering diagrams. Certain systems offer a limited event history. Even so, fault tracing is a difficult and laborious task.

### SUMMARY OF THE INVENTION

It is an object of the present invention to address these problems with the prior art.

According to a first aspect of the present invention, there is provided a method of monitoring a control process in a process plant, the process plant comprising: a plurality of plant items to be controlled, at least some of which have sensor means for obtaining a status signal indicative of the status of that plant item, and at least some of which have control means for controlling that plant item in response to a control signal; the method comprising receiving a plurality of input signals at least some of which have been derived from the said status signals; processing at least some of the input signals according to a control algorithm and generating a plurality of output signals from the processed input signals; selecting a first output signal being any particular data signal generated as the output of a control function under the control of the control algorithm, and used as a signal from which to begin analysis; tracing the derivation of that first output signal to its source or sources via the said control algorithm, and visually displaying the functional relationship between the source or sources and the first output signal which is a result of the control algorithm, so as to permit the tracing of a fault within the process plant from its effect back to its cause.

The invention thus provides a user with a visual display that permits fault tracing. Rather than having to leaf through potentially many pages of paper-based drawings and information before being able to trace the root of a problem, by signal tracing/derivation from, for example, the totality of signals available, the root cause of an effect may be located.

In preferred embodiments, a complete representation of the control process configuration may be obtained, this being organised in a logical manner according to the functional layout of the plant. Simulations of the internal computations of the control algorithm are possible.

Preferably, the method includes accessing live data from the control process. Not all live data need be included; once the control logic is mapped, internal derivation/calculation is possible.

Historical data may also be included in the preferred embodiment.

The method permits automatic generation of diagrams in the preferred embodiment. This may be populated with both live and simulated data.

The method may also, in a preferred embodiment, assist an operator in establishing the root cause of a problem through expert system reasoning.

According to a further aspect of the invention, there is provided a system for monitoring a control process in a process plant, the process plant comprising: a plurality of plant items to be controlled, at least some of which have sensor means for obtaining a status signal indicative of the status of that plant item, and at least some of which have control means for controlling that plant item in response to a control signal, the system comprising: storage means for receiving a plurality of input signals at least some of which have been derived from the said status signals; processor means for processing at least some of the input signals according to a control algorithm and generating a plurality of output signals from the processed input signals; and display means; the processor means being further arranged to permit selection of a first output signal being any particular data signal generated as the output of a control function under the control of the control algorithm, and used as a signal from which to begin analysis, and to trace the derivation of that first output signal to its source or sources via the said control algorithm, the display means being arranged to display the functional relationship between the source or sources and the first output signal which is a result of the control algorithm, so as to permit the tracing of a fault within the process plant from its effect back to its cause.

In one embodiment, the process plant includes a plurality of plant items to be controlled, together with an array of input/output cards which are connected to a network, and a processor. An input card receives signals from the various plant items, and outputs status signal data onto the network. The processor reads these status signal data, performs a control algorithm thereon, and produces output signals.

Some of these output signals are plant control signals which are sent via output cards to control items of plant. Others are sent to further processors for additional processing, and still others may be sent to an operator interface system. Thus for a chosen one of the cards, some status signal data may be generated directly by that card, whereas other status signal data may be obtained from different cards. Internal card data may be deduced from the card inputs and/or outputs.

Key output signals are identified by a selection algorithm. A diagnostic system according to one aspect of the invention simulates a part of the control algorithm and displays it graphically, and also applies reasoning on the basis of the control algorithm, in order (a) to identify key output signals, (b) to display the structure of the control algorithm, and/or (c) to derive the cause of fault conditions within the process plant. The user of the system may select which of these he wants as well. Processing of the signals only takes place for those objects which are to be represented graphically.

### BRIEF DESCRIPTION OF THE DRAWINGS

The invention may be put into practice in a number of ways, and one embodiment will now be described by way of example only and with reference to the following drawings, in which:

FIG. 1 shows a highly schematic view of a part of a process plant;

FIG. 2 shows a graphical window containing an array of plant control objects for display upon a monitor in a process plant control system;

FIGS. 3a to 3d show close-ups of parts of the window of FIG. 2;

FIG. 4 shows a menu hierarchy for selection of objects relating to different parts of a process plant;

FIGS. 5a-5g show the build-up of a graphical display of the control application software for a plant item;

FIG. 6 shows a part of a diagram of the control application software for a plant item in the case where there is no data available at the network inputs;

FIG. 7 shows a graphical window containing an array of sequence control objects for a particular part of a process plant;

FIG. 8 shows a selection of the sequence control objects of FIG. 7, in different sequence states;

FIG. 9 shows a graphical representation of an individual sequence step in a sequence of events within a process plant;

FIG. 10 shows an exemplary table of values for a selected network input object;

FIG. 11 shows an exemplary table of values for a selected analogue network item;

FIG. 12 shows the graphical representation of a chain of simulated data;

FIG. 13 shows an exemplary table of values for a selected network output register object;

FIG. 14 shows a diagram indicating how a given network output register signal is used;

FIG. 15 shows the parameters of a function block in tabular form;

FIG. 16 shows in tabular, the graphical display of general information relating to the function block of FIG. 15;

FIG. 17 shows the graphical representation of notes associated with a given object;

FIG. 18 shows a graphical representation of a sequence at the commencement of a fault trace operation;

FIG. 19 shows a graphical representation of the sequence of FIG. 18, as it is traced backwards;

FIG. 20 shows a graphical representation of the sequence of FIG. 19 as it is traced further backwards;

FIG. 21 shows a graphical representation of the sequence of FIG. 18 as it is traced yet further backwards;

FIG. 22 shows a graphical representation of the sequence of FIG. 18 as it is traced still further backwards to the root of a problem therein; and

FIG. 23 shows a graphical representation of a tabular display of the status of a plant item located at the root of the problem in the sequence of FIGS. 18 to 22.

### DETAILED DESCRIPTION OF THE PREFERRED EMBODIMENT

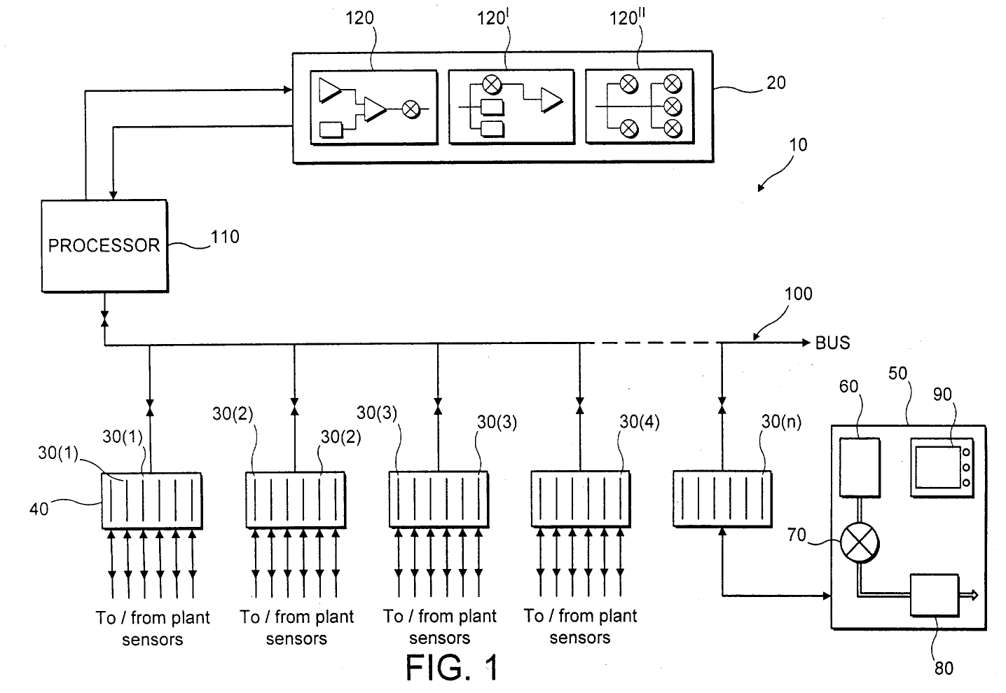

FIG. 1 shows a highly schematic view of a part of a process plant 10, in this example a power station, including a user control interface 20. There are, of course, many different plant control systems available and the following describes the application of one embodiment of the present invention to one particular distributed control system. It is to be understood that this is by way of example only. Although different plant control systems have different specific implementations, the principles underlying the invention are equally applicable to a wide variety of different plant control systems.

The process plant contains many plant items (possibly several thousand), most of which have an electrical output (from a sensor, for example, to allow monitoring of plant item status), and/or electrical input (to a switch, for example, to allow remote control of the plant item). The electrical outputs from the plant items are usually in the form of a voltage representing a binary 1 or 0 (e.g. from a switch) or an analogue current in the milliamp range (e.g. from a gas turbine). Each of the plant items in the control system is connected to an “intelligent” input/output data card 30(1), 30(2), 30(3), 30(4) . . . 30(n). A plurality of data cards are usually grouped together on a single rack; the data cards 30(1) are each held on a first rack 40 as seen in FIG. 1. It is also usual, although by no means essential, to group together data inputs to the cards from physically proximal plant items. Thus, for example, inputs and outputs from a gas turbine and its ancillary plant items may all be connected via the first rack 40.

In addition to individual plant items, plant subsystems may also be connected to a data card. For example, a water treatment plant 50 is shown schematically in FIG. 1. The water treatment plant itself may be purchased separately from a third party and might include pumps 60, 80, a valve 70, and a monitor screen 90. Although as a third party item the internal plant items of the water treatment 50 are not separately remotely controllable (in this example), a single input/output port is usually provided to allow at least control and monitoring of the status of the water treatment subsystem.

The input/output cards 30(1), 30(2), . . . 30(n) are each connected to a data bus 100 which in turn is connected to a processor 110. The processor 110 communicates with the user control interface 20 which includes a plurality of computer screens 120, 120′, 120″. Representations of plant items and the like are displayed upon the screens in a manner described below.

The skilled reader will readily appreciate that, at least in general terms, the structural layout of the control system as shown in FIG. 1 is known as such and no further description thereof will be given.

The manner of processing and display of the interaction between the various plant items, together with the logic applied to these, the inclusion of live and historic data from the plant items and so forth will now be explained.

Various hardware platforms may be chosen to carry out this processing and display. In general, it is desirable that the hardware includes communication and storage facilities (such as the processor 110) on which to execute the processing, and a screen-based display (such as the screens 120, 120′ and 120″) by which a user can interact with the system. For example, a networked personal computer or a server system with an X-terminal display is particularly suitable. This allows multiple users to access the same data and to share generated diagrams with each other, to allow off-site diagnosis via a LAN or WAN, for example. It is also desirable that the hardware be capable of importing live and historic data from selected plant items, for processing and display as well. Such information may be obtained from external storage devices or may be read in to the storage facilities associated with the processor 110.

The process for the generation and display of information to a user may be conveniently broken up into a series of stages, as outlined below.

Reading the Raw Data—Processing

Most distributed control systems or programmable logic controllers provide application code in a diagrammatical form such as function blocks, ladder logic, or sequential function charts, or alternatively in the form of a textual or tabular description. Typically, these are capable of export in ASCII text format along with their associated databases. In the present example, a number of files are produced by the control system for each card 30(1) . . . 30(n), although not all cards generate all files. In the presently described embodiment, the following files are generally available:

(1) An address file which identifies inputs and outputs from the network, and for some cards, from the local input/output subsystem.

(2) A structure file which identifies executable application code.

(3) A limit file which identifies analogue input information and the limits at which ancillary binary signals will be generated. These may, for example, be alarms or action triggers.

(4) A parameter file which lists the initial value for operator modifiable parameters, such as set-points and control tuning parameters.

A database lists the use that each input/output card 30(1) . . . 30(n) makes of network data, and includes information that identifies the signal, together with a descriptive text for each such signal. Fields which are considered relevant (as explained below) are extracted into a text file. A list of the title of each plant item is also usually required, as the descriptive text of the signal does not in many cases describe the item to which it refers in sufficiently specific detail to allow unambiguous identification of a particular plant item. For example, the raw signal may simply be labelled “process signals from drive”.

Pre-processing of the raw data merges the address, structure and parameter files, and produces a new file in a format which is faster to read, having had some preliminary parsing carried out. A tag, and more detailed descriptive information, is also added. Preprocessing also parses and textually simplifies the limit files.

In general terms, pre-processing utilises the fact that, for a given DCS, the files are known to be generated in a specific format. The pre-processing strips out that information which is not considered necessary for the ultimate processing and display, and extracts the information that is considered necessary into a more convenient format.

The details of pre-processing depend to a great extent upon the particular DCS in the process plant. Moreover, the skilled person would have no difficulty in implementing such pre-processing upon the basis of the above principles, and a more detailed discussion is considered neither appropriate nor necessary. Typically, a database is provided which automatically translates the raw data files into pre-processed files which are in a more convenient format.

The purpose of pre-processing is to reduce the start-up time of the system, which in turn improves the overall performance thereof. It will also be appreciated that preprocessing is not a fundamental requirement of the system of the invention.

The pre-processed files are retained on storage media within the hardware platform for the system.

Reading the Raw Data—Build-up of Internal Representation

There are two modes of start-up for the system. The first mode allows the user to specify the location of the various file sets that the system requires, prior to it loading them. This configuration may be changed and saved. The second mode automatically reads the files from the specified saved file set locations.

The file reading and structuring algorithm preferably employs object orientation to build up an internal representation of the process control software. Each object which is used has a set of attributes and relationships with other identified objects. In the presently preferred embodiment, G2, distributed by Gensym Corporation, of Cambridge, Mass., USA, is employed, although other forms of representation can be used. G2 is a real time expert system construction environment. In the present example of a control system, which is based on function blocks having some additional tabular information, the representation includes the following objects:

(1) Control cards—These are the basic building blocks of the hardware, and include a number of different processing modules, analogue input and output cards, digital input and output cards and specialist control cards. Each card has a defined type and functionality, and is identified within the system by its network address.

(2) Network data items—These are data points that are transferred, in the presently described embodiment, via dual redundant data buses. Each data point is identified by the network address of the card that it is transmitted from, by the register number (within the card) in which the data is contained, and, for packed binary data, by the bit number within the register. The network address of the control cards is (in this example) in the form of a three-number identifier, based on connectivity information and physical location, and so each network data item is uniquely identified by a four- or five-numbered decimal code, such as (1, 7, 42, 12). In addition, textual information and descriptive text are stored within the network data item. Network data items sourced from the same card are linked together and also linked to the card for speed of look-up. Network data items are the main means by which historical data may be acquired and are also a significant source of live data from the various plant items.

(3) Network input and output registers—These identify the flow of information into and out of the control cards, and are usually identified in the address files. A few specialist cards might have fixed register allocations. The sum of the addresses referenced or implied in network input and output registers forms the list of network data items. Both inputs and outputs are used, as bit-packed data may be referenced as the word in some contexts and as individual bits in others.

(4) Local data items—As values are calculated within cards, local storage is used for the results. This local storage may then be used as an input to one or more further calculations. Local storage is not normally transmitted onto the network.

(5) Function blocks—These provide calculation and logic functions. All have multiple inputs, and most have multiple outputs. In many cases, the outputs come in pairs, one network data item and one local data item. Both are given an identical value. The system has a definition of each function block type, which contains

(a) the parameter names

(b) the parameter types (for example, binary or percentage)

(c) parameter direction (input or output)

(d) a calculation method

(e) a backward reasoning method

(f) a parameter description display

(g) a function description display, and

(h) a descriptive title for the block type, such as “delayed on timer”

(i) an acronym or mnemonic for the block type, as used in the process control software engineering tools.

(6) Parameter array—As each individual function block is read, its parameters are identified, and linked to the associated data storage area, be it local data or network input or output registers. In some cases, individual parameters take inversions of binary or negations of analogue data, or select bits from words. This information is stored within the parameter array.

Preliminary Processing

The loaded system contains the information about many thousand signals, but does not at this point have any defined user display. The next stage in the processing of the data is the automatic construction of a user interface derived from the data that have been read in. It is particularly desirable that no or minimal customisation of the DCS of a particular plant be necessary, other than the data that can be obtained from primary sources. In this example, the operator's primary control interaction with the DCS is through one or more screens via which he can stop and start plant items, modify set points, or commence sequences of operations such as turbine start-up. Each of these operations is associated with an instance of one of several types of function block. For example, a proportional controller (which generates an analogue output and controls the temperature of the plant and the feedback control), a solenoid control block (which should have a binary “on/off” output), and a valve control block (which has three states, open, shut and stop) may form the key to control of the plant, with various other blocks being dependent upon the state of these.

It is sometimes necessary to examine a number of different parameters or trace a data flow before the item can be definitively identified. The latter occurs when none of the parameters to a significant function block is an identifiable external item. The programmer provides means to automatically search through the pool of data for the system, identifying neighbouring function blocks and examining them for use of data identifying the related functional plant item. Generally, it is only necessary to trace one stage backwards from the block. For a typical process plant, the exercise of reviewing the different data blocks, picking out those which are key, and then following through the dependent and resultant functions is part of the design process for the application, but is not onerous. Execution time for this aspect is a few seconds during the system start up. The addition of new plant items to the system is then automatic, just requiring the new data files to be loaded.

The process of selecting the key blocks and working backwards from there is facilitated by the use of the “engineering drawings” which are generally provided when the plant is originally installed and which set out, on paper, how one signal is functionally linked to another.

Once the plant items to display are identified, they are grouped together in conveniently-sized groups according to their tag identity, which in the presently described system is normally codified in a structured manner which reflects the physical layout of the plant. In particular, sequences and preselectors are separately identified and are differentiated from direct plant control objects. The grouping operation may be plant-specific, although for power plant it is often the case that the hierarchical coding structure may be implemented simply.

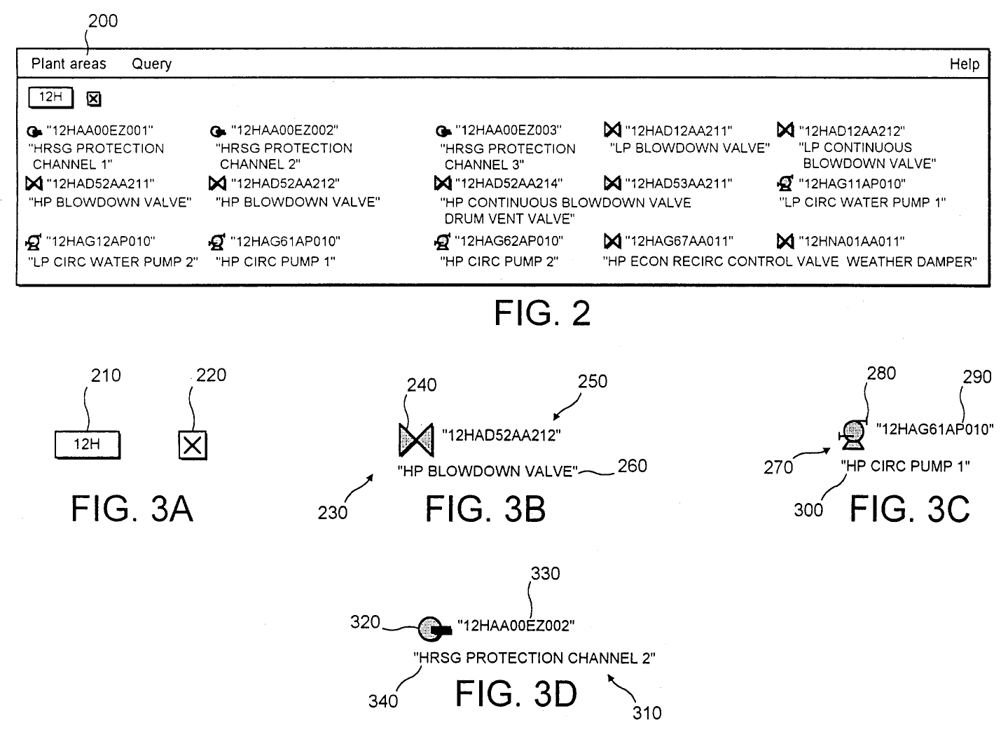

The type of function block often implies the type of plant item being controlled. FIG. 2 shows a screen shot of an array of objects which would be employed in a typical power plant. Various parts of this screen shot are shown expanded in FIGS. 3a-3d.

As explained above, the control system of the described embodiment divides the process plant into different physical areas, and the particular area of interest can be selected from a menu 200 in FIG. 2. As seen in the top left-hand corner of the window in FIG. 2, and in close-up in FIG. 3a, the plant area presently shown is labelled 12H. A button 220 is provided to allow the window to be dismissed.

Three of the various objects in FIG. 2 are shown in FIGS. 3b, 3c and 3d respectively. The first object 230 relates to a valve. As seen in FIG. 3b, a schematic representation 240 of a valve is included along with its identification code 250. The title 260, as added during pre-processing, is also included and describes the specifics of the valve in sufficient detail to allow it to be unambiguously identified. As will be explained below, clicking on the icon 240 causes the algorithm to generate a diagram starting from the checkback (feedback) telegram associated with the function block that controls operation of this output group. In this case, the identification letters AA in the identification code relate to valves. FIG. 3c shows a close-up of a second object 270. This relates to a pump and has a suitable icon 280. Once again, an identification code 290 and unambiguous title 300 are included. Clicking on the pump icon 280 generates the relevant functional diagram as explained below. The two letters AP in the identification code 290 identify the object as a pump.

FIG. 3d shows a close-up of a third object 310 in FIG. 2. This relates to a non-specific plant item, and this is represented by the icon 320. In order to avoid the necessity of many different icons, items other than valves or pumps are, in the present example, considered to be non-specific plant items. For example, protection signals, heaters, fans, turning gear, and some load control signals are considered non-specific. As with the valve and pump objects, the non-specific plant item object contains an identification code 330 and a title 340.

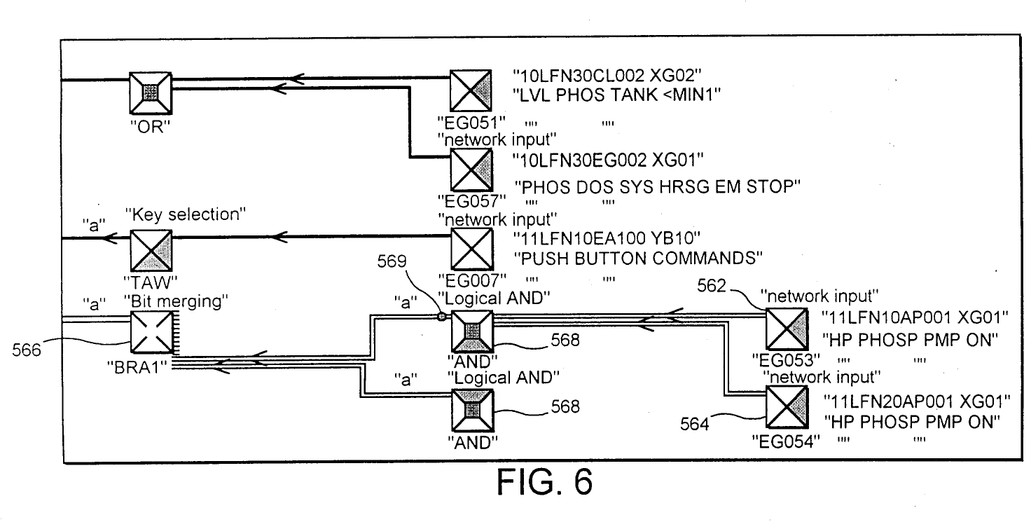

A visually similar technique is used for control and diagnosis of sequences, which will be described in connection with FIGS. 6 to 8 below.

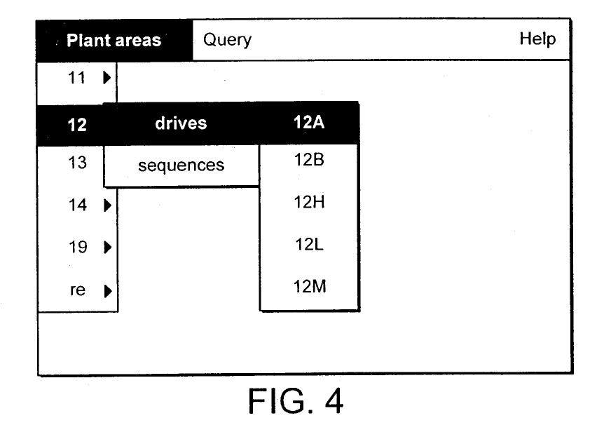

It is advantageous to generate a menu hierarchy to reflect the display groupings. This enables the user to go rapidly to the object of interest, which may for example be malfunctioning in some way, or to monitor the process of a group of sequences. FIG. 4 shows a typical menu hierarchy to allow selection of certain areas and, in turn, sub-areas of a process plant, and also sequences and sub-sequences.

Display of the Control Application

To display the control application software for a drive, such as a pump or valve, the icon representing the chosen drive is selected by clicking upon it with a mouse. The displayed object is linked to the function block that controls it. The output parameters are examined to locate the check-back signal, that is, the signal that gives general status indication of the particular drive. In most cases, this is connected to a network output register, but some check-back signals have additional binary information inserted before being output to the network. Signal derivation is then commenced from the network output.

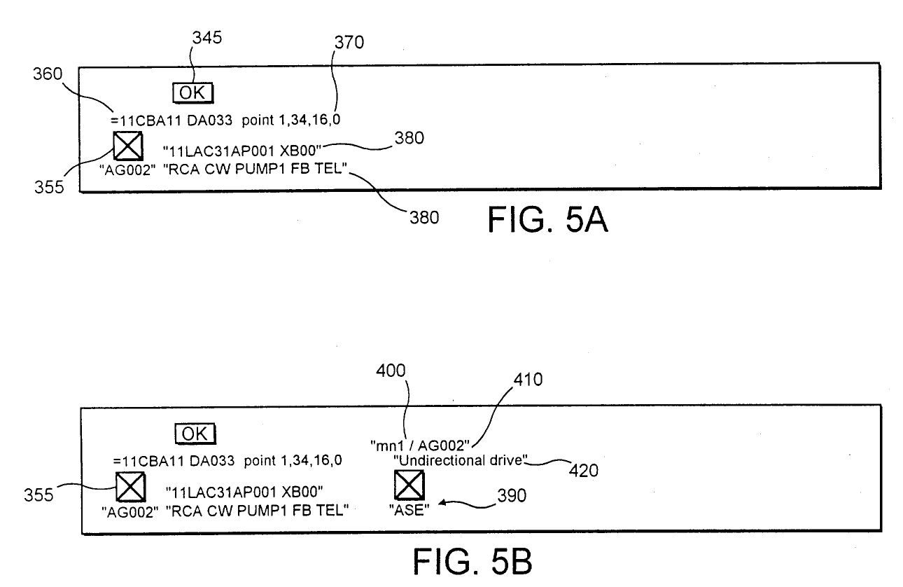

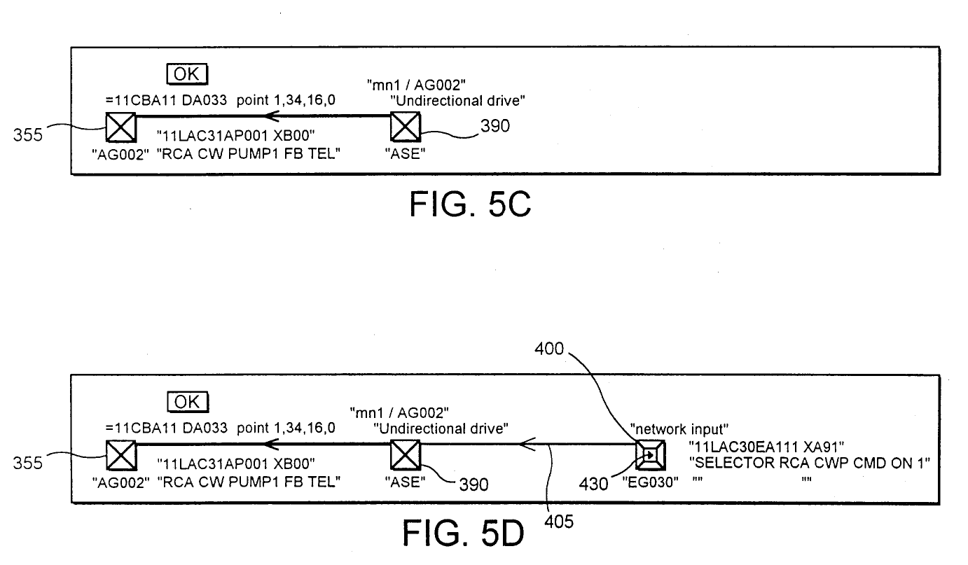

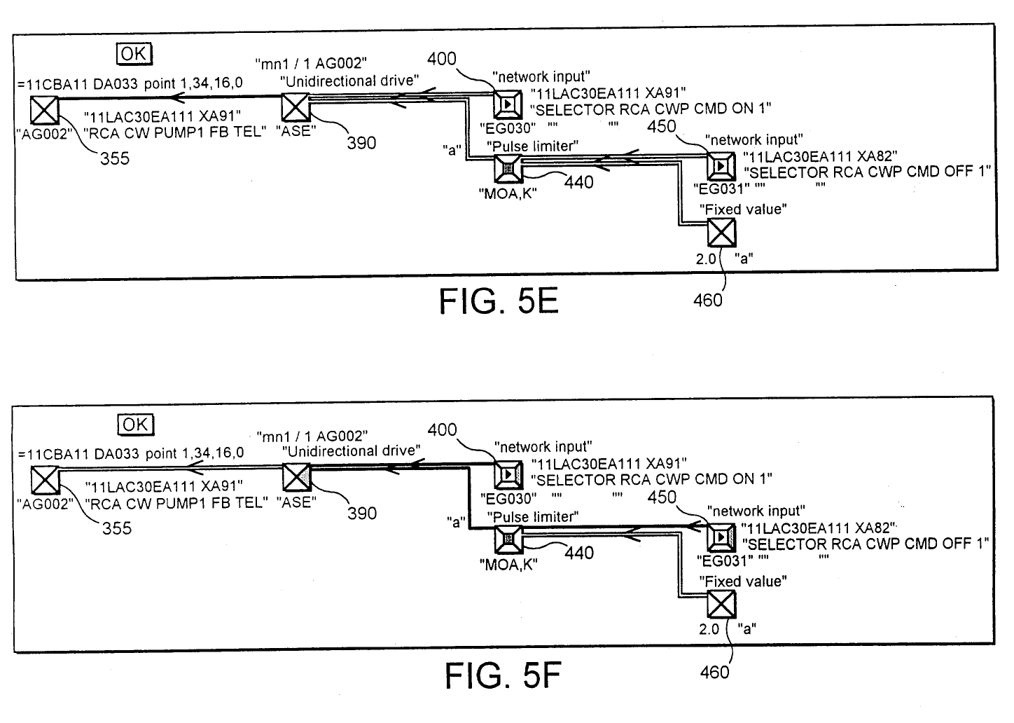

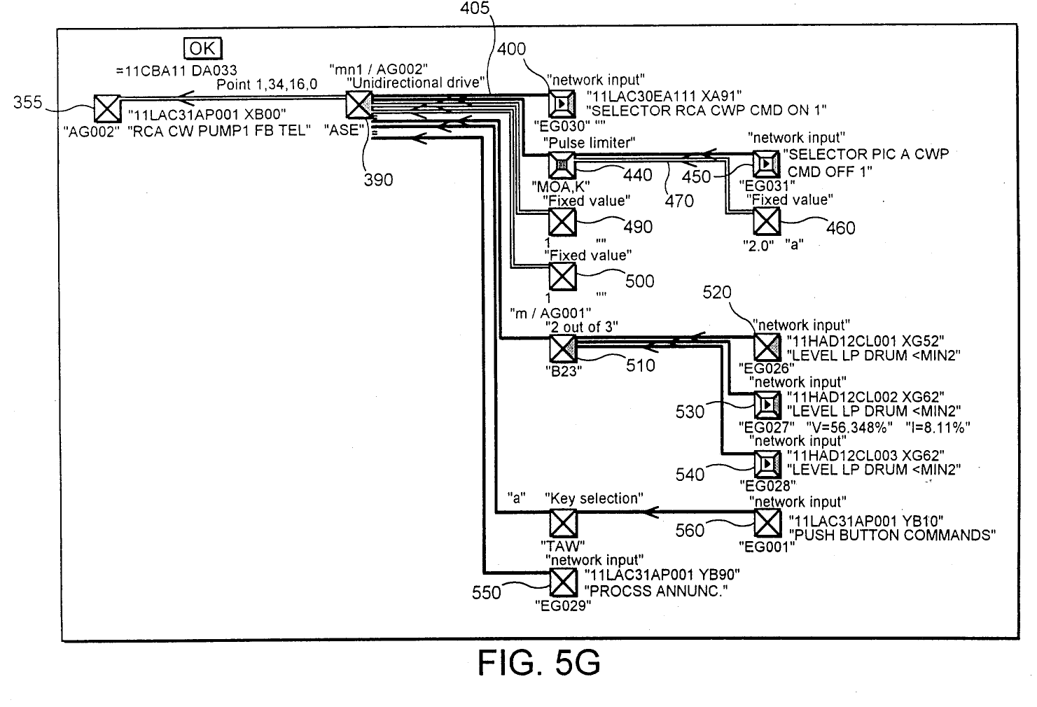

Firstly a window for the drawing is created, and a part of this is shown in FIG. 5a. Various display management objects, such as descriptive text and a mechanism for removal 345, are placed upon it. Next, a network output object is drawn. This may include an icon 355, and the title 350 (“RCA CW PUMP FB TEL”) which identifies this object as indicative of the status of an RCA CW pump. Also displayed is the physical location of the processor card, labelled at 360 as “11CBA11 DA033”; the network address of the data, labelled at 370 as (1, 34, 16, 0), a block type mnemonic 357, and the tag code 380 (“11LAC31AP001 XB00”).

Next, the parameter that is the data source for the register is identified, which in turn identifies a function block. As shown in FIG. 5b, the function block 390 is drawn level, and to the right of the output register. The function block 390 in FIG. 5b coordinates operation of the pump. Included with the function block 390 are the type mnemonic 395 for the function block (“ASE”), the output parameter RM1 (a status message) (400), the register 355 which is used (“AG002”) and the function of the function block (“unidirectional drive”) 420. The connection describing the data flow is drawn, as shown in FIG. 5c. The style of connection represents the type of data being transferred.

In the case of the first function block 390 which is drawn, the output data from this function block 390 is available on the network. Thus, the structures necessary to fetch the data are created, and an asynchronous data fetch commenced. The diagram construction may continue while data is being fetched. When the data arrives, it is then stored as the value attribute of the function block and also the value attribute of the connection. The style of the connection is modified to indicate it contains valid data, and for binary inputs, what the value of the data is. This technique is readily accomplished in G2.

As shown in FIG. 5d, the first input parameter of the first function block 390 is identified and drawn as a block 400. The data flow 405 is then drawn. The first input parameter comes from a network input register, identified by the label EG030, and the data's tag 410 and title 420 are shown on the right of FIG. 5. The fact that the block 410 is a network input is also displayed. For those network inputs for which the application has corresponding data source software, an arrow button 430 appears within the block 400. A single click on this arrow button 430 allows the derivation of the data item to be obtained.

As the block 400 represents a network input, data tracing (i.e., growing of the branch shown in FIG. 3d further to the right) is halted.

Next, therefore, the second input parameter from the function block 390 is traced, using the same principles as described in connection with FIGS. 5a to 5d above. FIG. 5e shows the entire trace for the second parameter, which includes a second function block 440, a second network input block 450, and a constant or fixed value block 460. As with network inputs, constant values cause data tracing to be halted at that point.

The right hand sides of the function blocks are coloured in if the data shown at their output connections is exportable from the control system, whether it is actually exported or not. Once live data appears at the network inputs represented by the two network input blocks 400, 450, the lines 405, 470 and 480 (indicating the direction of data flow) change colour to signify that live data is present.

FIG. 5g is a full screen display showing all of the parameters which have been traced. Two further fixed value inputs 490, 500 are also connected to the first function block 390; a third function block 510 connects to the first function block 390 and this in turn has three network inputs shown by blocks 520, 530 and 540. The third function block 510 is a “two out of three voting” function block and the three network inputs, shown by the three blocks 520, 530 and 540 respectively, have been identified as limits generated from analogue values. The diagram shown in FIG. 5g identifies the current value of the analogue and the value of the relevant limit for two of the signals. The analogue value is not available for the other signal, but its binary status is known. The first function block 390 also takes two further, separate network inputs and these are indicated at blocks 550 and 560 respectively.

Placing the parameters in this order generates a diagram that does not contain any crossings, and is of a predictable layout, being in a tree-like form. One additional rule is required to ensure that the diagram is finite, and this is to cater for connections which loop from an output to an input of the same block, either directly or indirectly. This is handled by recognizing objects that have already had representations placed on the display. Such objects have the first instance flagged as such by a marker within the object, and subsequent copies are flagged with a different marker. In the case of function blocks in which the representation already exists, a copy representation is added, but the input parameters are not traced. A facility is provided to show the relationships between these copied objects and the original objects.

FIG. 6 shows a screen shot of a part of a diagram where there are network inputs and no data is available (the two inputs 562, 564 on the right-hand side), a BRA1 block 566 which merges bits into a word, and two displays of one AND block, 568, 568′, at the bottom centre of the picture. The BRA1 block 566 uses data derived from a single AND block for two parameters, so both connections are shown. The upper connection is shown with its logic inversion, (a small circular object 569 on the connection). The first time the AND block is shown, its inputs are traced. The second time it is used, the block is shown, its first copy 568′ being marked with a darker-coloured lower section, and its second copy 568 being marked with a darker-coloured upper section. This time, however, the data inputs to the AND blocks 568, 568′ are not traced. This reduces the diagram size and also guarantees that any diagram will be finite, as data looped back from output to input of a block (even indirectly) will not result in infinite displays of the same loop.

The net result of the above algorithm for drawing is that a diagram of reasonable size can be generated, although it is often larger than can be displayed on the screen in its entirety at normal scale. Scrolling facilities permit rapid data following. In some cases, connections can be quite long, and a facility is provided to follow a connection to its source or destination, repositioning the diagram to centre on the object at the relevant end of the connection.

Display of Sequences

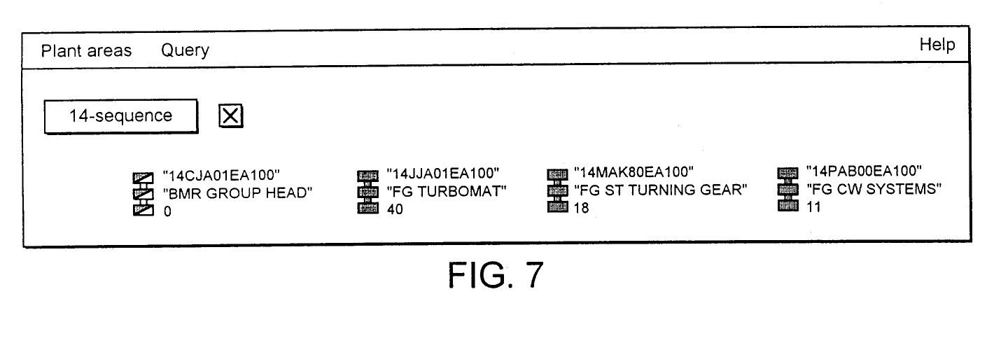

The above Figures have illustrated the tracing of the control application for a drive. A similar process can also be carried out to allow sequences to be displayed. In the preferred embodiment, a sequence menu option is also provided in the menu hierarchy (FIG. 4). FIG. 7 shows a screen shot of the various sequence controllers for a given plant area (11, 12 . . . in FIG. 4). In the example shown there are sufficiently few that they fit within a viewable area, but if required, deeper levels of structuring may be used.

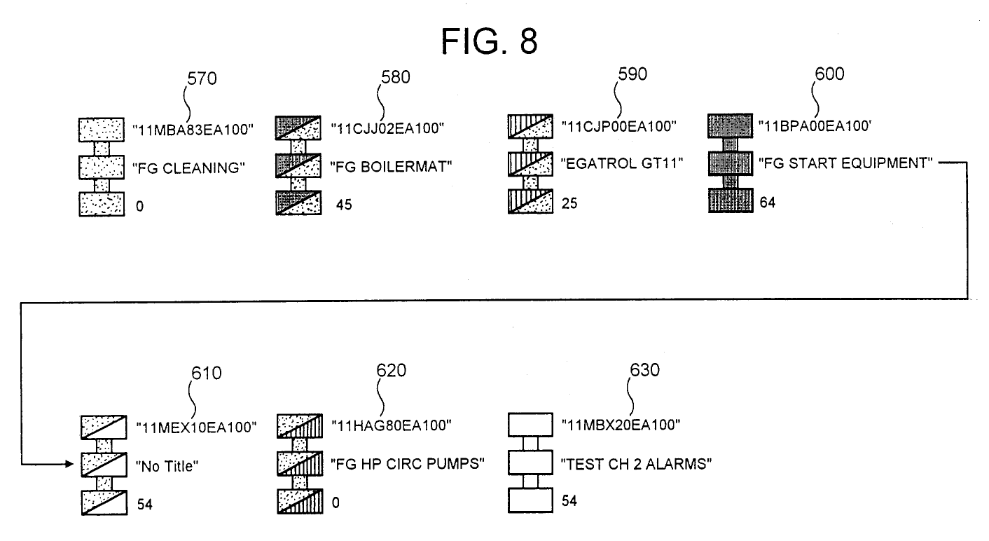

The sequence control groups obtain information from the DCS as to the current state of a sequence, and the active step number. The state of the sequence is signified by its colour, and these are illustrated in FIG. 8. Although shown in black and white, it will be appreciated that various colours are in fact used to denote different sequence states.

The left-hand sequence 570 is in an unknown state, and is displayed in solid blue. Second sequence 580 is running to on, and is two-tone green and blue. The third sequence 590 is running to on, but has timed out, and is in two-tone yellow and blue. The fourth sequence 600 is in a “on” state and is shown in solid green. The fifth sequence 610 is running to off and is two-tone blue and white. The sixth sequence 620 is running to off, but has timed out, and is in two-tone blue and yellow. Finally, the seventh sequence 630 is in an “off” state and is solid white. The colours chosen and the display effects may be customized to follow normal site conventions.

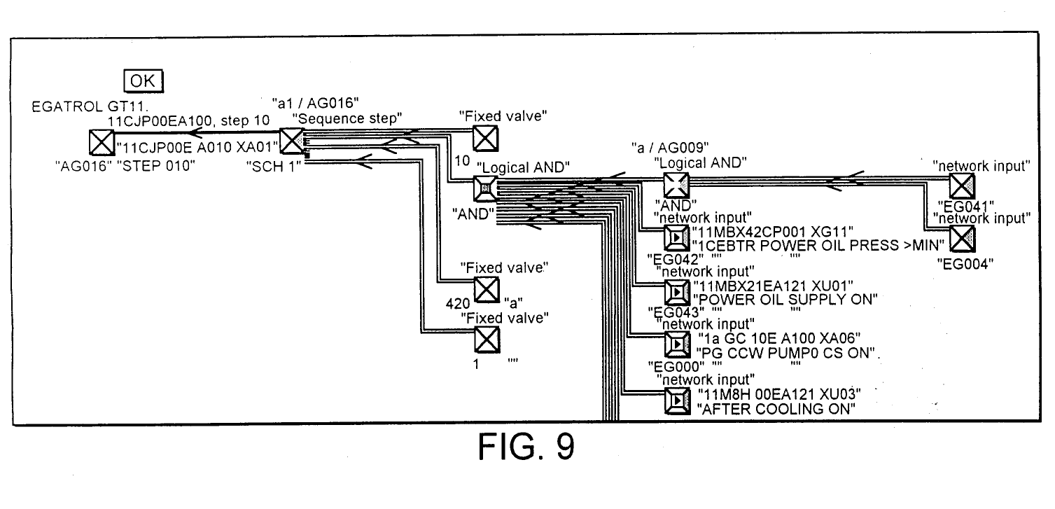

FIG. 9 shows an individual sequence step which has been built up in an analogous manner to the control application for a drive shown in FIGS. 5a to 5g. Each sequence is constructed from a sequence control block (such as the control block 640 shown in FIG. 9), via which the sequence is started, or stopped, and which can report information on the progress of the sequence. Each sequence also contains a set of sequence step function blocks, one for each step. These blocks are numbered using one of their input parameters, and have a number of inputs which may allow them to enable their actions or to control the order of execution of the steps. In FIG. 9, the second input parameter is the enable condition, which is derived from a larger number of signals through an AND block 650.

The sequence object (identified by tag and descriptor) gives access to the sequence control block, via one of its output parameters which is connected to a network output register, or to the currently active sequence step block, or to any selected step, indexed by step number. Selection of steps is through a list of the steps that are present.

Displays of Network Data

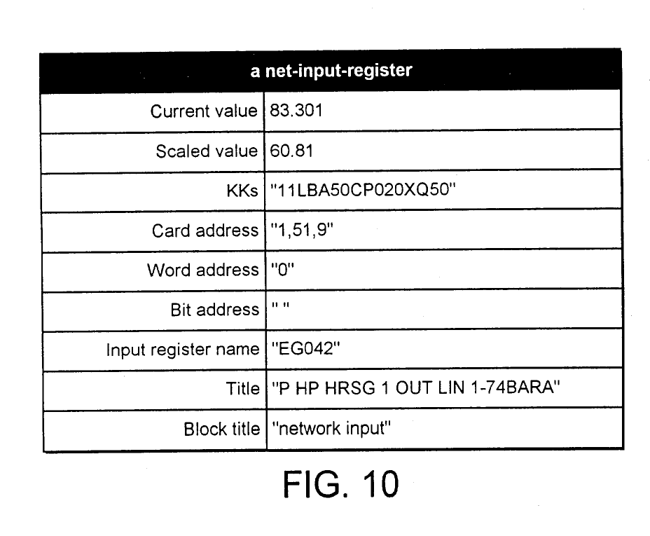

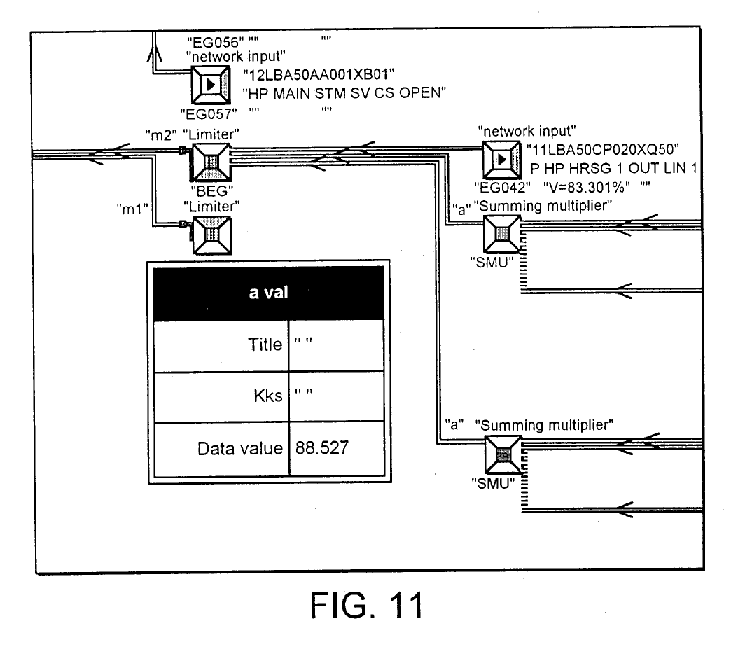

Any item of data on the network may be selected by using a text search mechanism on the tag name. Any of a number of well-known text string matching techniques may be used, and, preferably, either the partial or full tag name may be used for searching. In the latter case, only one item will be identified, since the tag and name has been selected to identify a signal uniquely as explained above. FIG. 10 shows the results of a search for the tag “11LBA50CP020 XQ50”. Various attributes associated with this item of data are displayed in the table of FIG. 10.

Where only a partial tag name is used to search for an item of data, typically a number of items which match will be located and these are preferably displayed in a table. Any item in the list may be selected either for a display of its derivation, or for a tabular display of the objects and data which are in turn derived from it.

Live Data Propagation

A variety of data items may be obtained from a data base of historical and current data, depending upon which values have been stored. The historical database obtains its information from the control system's network data, and besides storing the historical information maintains a copy of the live current data. This storage database may or may not have been configured with this application in mind, so that the data availability may be incomplete. The method by which the described embodiment handles this is to allow data to have a state of ‘unknown’, which is its initial state, and only to populate it with real data at a later stage.

Normally, it is found that the network inputs, the network output that the diagram started from, and local data items whose values are reflected in network items are stored. The items in the last set are associated with function blocks other than the first, as the connection is always through a local data item. These local items are never visible upon the network. In general, however, the function blocks often have pairs of associated output parameters where one is connected to a local data item, and the other to a network output register, both items having identical values. It is thus possible to establish the equivalence of a local data item and a network value. In cases where the network item is not supplied as an output parameter, and for function blocks where persistent hidden internal states are not used, it is usually practical to perform a calculation within the described embodiment which replicates the calculation on the control card.

In the embodied system, the data is fetched from the historical or current database, but there are communications interfaces available that can fetch local data items on request. These could also be used. Other control systems may provide a variety of mechanisms for obtaining information and advantage may be taken of these alternatives.

The method by which the data is obtained is explained below. The relevant network data item is identified, and a connection to the historical/current database is established for it. In preference, an exception reporting mechanism is used for current data, particularly for binary data. As data is received from the database, it is propagated to the relevant blocks, and the output connections of those blocks. Negation objects invert binary data and negate analogue data, and bit selection objects select individual binary items from bit packed words. The data is then presented through the connections to the inputs of further function blocks. The receipt of a new value at a connection stimulates a recalculation of the function block of which it is an input. Certain function blocks may also be recalculated on a timed basis.

In some cases, and for some data values, it is possible to back-calculate an input from a known output. For example, if a OR block has a true output, a false input and an unknown input, it can be deduced that the unknown input must be true. Clearly, care must be taken to distinguish between deduced values and known values in case the status of a known value changes to unknown, and a deduction is then made, based upon a previous deduction which may no longer be valid. Drive control blocks reflect some of their binary inputs directly in their packed check-back signal, so these may be safely deduced.

Any residual items that are still unknown may then be obtained by direct request of the appropriate cards. The use of the above mechanisms provides alternative means by which data may be obtained, and thus the system may be most appropriately configured for each installation with either the historical data or current data, the direct link (or several direct links if this enhances the performance and is cost-effective), or both.

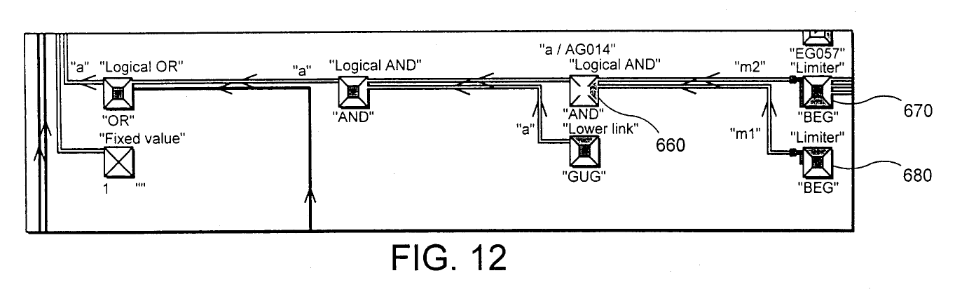

FIG. 12 shows a diagram of a chain of simulated data, with an item 660 obtained from the network overriding the simulation. The two BEG blocks 670, 680 on the right-hand side of FIG. 12 are actually two different outputs of one actual block, a limiter function, which indicates that the analogue signal shown as the first parameter of the upper instance is not exceeding the upper and lower limits defined by the second and third parameters. The logic is inverted to indicate that the analogue signal is within the respective bound, and then the two signals are combined in an AND block, the results of which mean Signal Within Limits.

The use of historical data in particular can be extremely helpful in the tracing of faults, as will be explained below, as, in effect, a “video recording” of a sequence of events can be replayed at any desired speed. The root cause of a problem, for example in starting a part of the process plant, may then be identified. Previously, it was necessary simply to start a sequence at the beginning and try to watch the screens to see the point at which the sequence hung. At this point, all of the various plant items and their states needed to be checked (sometimes it became necessary to do this manually) until the root cause of the problem was located. Lost time in any process plant usually costs money and, in the particular case of a power plant, starting and restarting gas turbines several times to try and locate a fault during system start-up can cause significant wear and tear to the turbine itself.

User Facilities on Diagrams

In addition to the diagrams generated as described above, it is also useful to allow the user to view details of the various blocks or objects upon the screen. Such information may be provided either permanently on-screen or provided from a menu obtained by mouse selection of diagrammatic objects. The following, non-exhaustive, list of information may in particular be displayed:

(1) Network Outputs

(a) the tag name

(b) the tag descriptor

(c) the network address of the tag

(d) the table of information about the network signal

(e) the value of the network signal, and

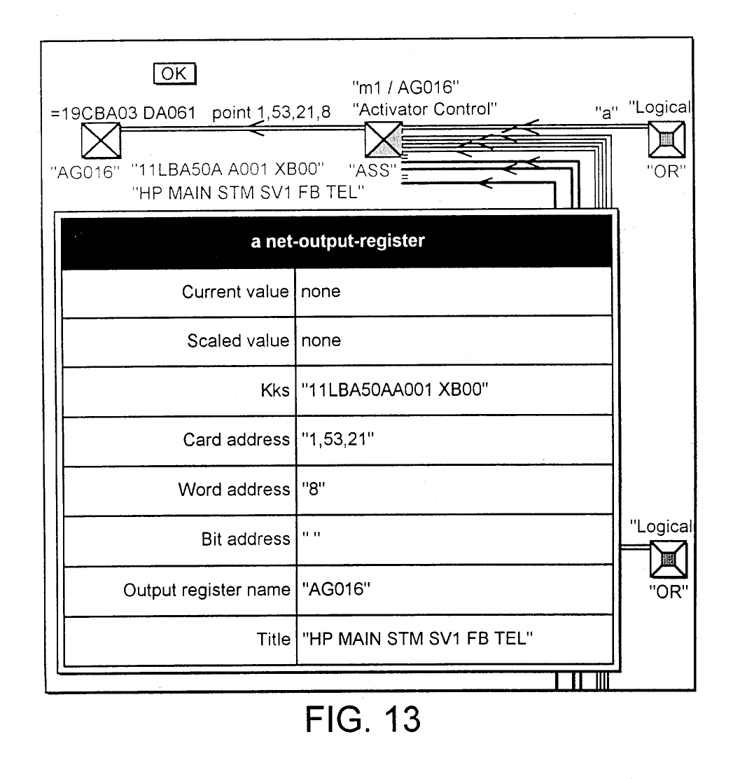

(f) the table of objects that are directly affected by the value of the signal, i.e. drive objects which reference it in their controlling application, or network data which is calculated using it. The application code for each of these may then be readily displayed. Items 1(a) to (c) are permanently provided on screen, as seen in FIGS. 5a-5g. Item 1(d) above is shown in FIG. 13.

(2) Connections

(a) An indication of the state of binary signals, or an indication that the connection's data is available upon selection

(b) a table of information about the connection.

(c) the data value in the connection, and

(d) for bit-packed items, or data derived as one bit from a bit-packed item, the data condition connected with each (or that) bit, where the meaning is system-defined, either at the source or destination of the data.

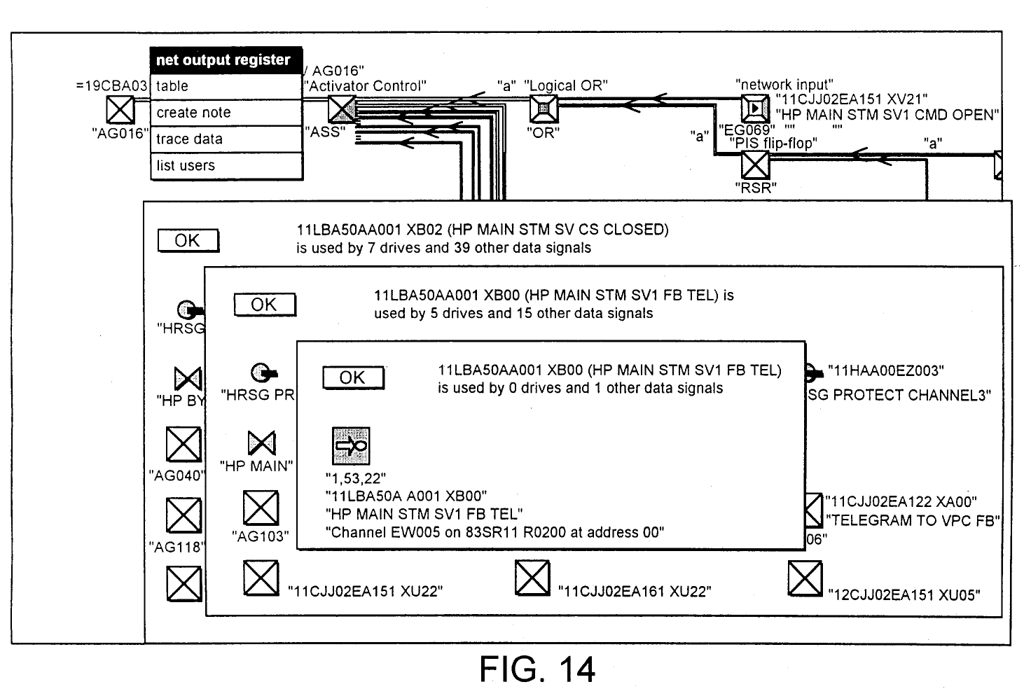

Item 2(a) is shown in FIG. 14. This shows the usage of a signal, in particular the network output register shown in FIG. 5a. It is a bit-packed word. The system uses it in three ways. Firstly, as a word it is used by an output card, which outputs signals to control the valve. Secondly and thirdly, it is used in the form of two individual bits, the opened and closed signals, by a large number of other parts of the software. Thus, three windows of information 700, 710 and 720 are generated, one for each usage. The drives, outputs and other data signals that use the data are all shown, and a single mouse selection can show the relevant derivation diagram.

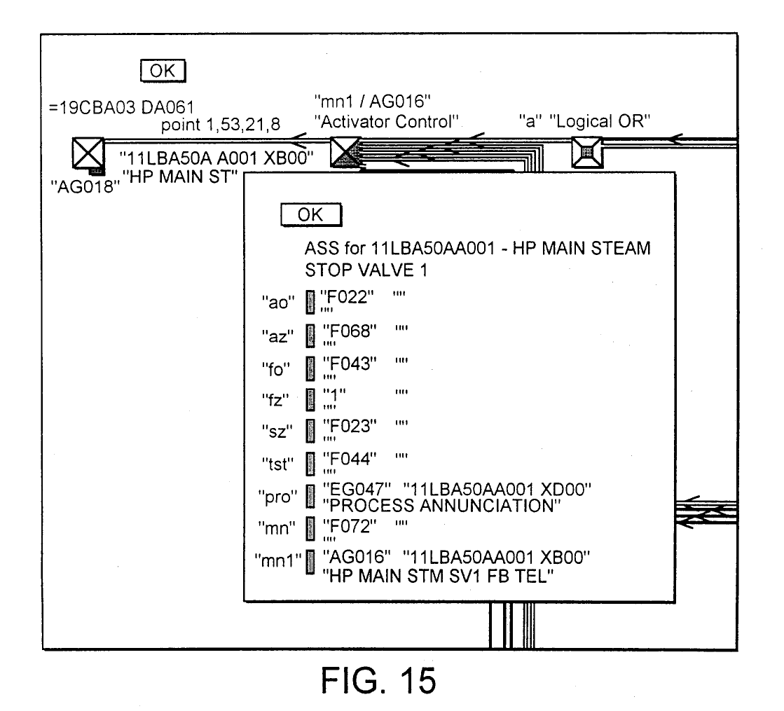

Item 2(d) is shown in FIG. 15. The identification of the data used for the PRO and RM1 parameters is the method used for determining the plant item controlled.

(3) Function Blocks

(a) the function block acronym, short description and output parameter acronym;

(b) a table of information about the function block;

(c) a tabular display of the input and output parameters of the block, with parameter name, the designation of the card's internal variable associated with the parameter, the value of any constant or modifiable parameter, and the tag name and descriptor for data that is networked. The display is dynamic, as the current values are also indicated;

(d) help information about the function block, allowing an unfamiliar user to understand what its function is without reference to manuals;

(e) an indication that the function blocks output is determinable from the network;

(f) an indication that the function block is attempting to simulate the control systems calculation, and whether or not it is returning a valid result, the latter if a settling time is required, or if there is insufficient data, and

(g) an indication that this is one of several instances of the same function block on the diagram, and whether it is the first or not.

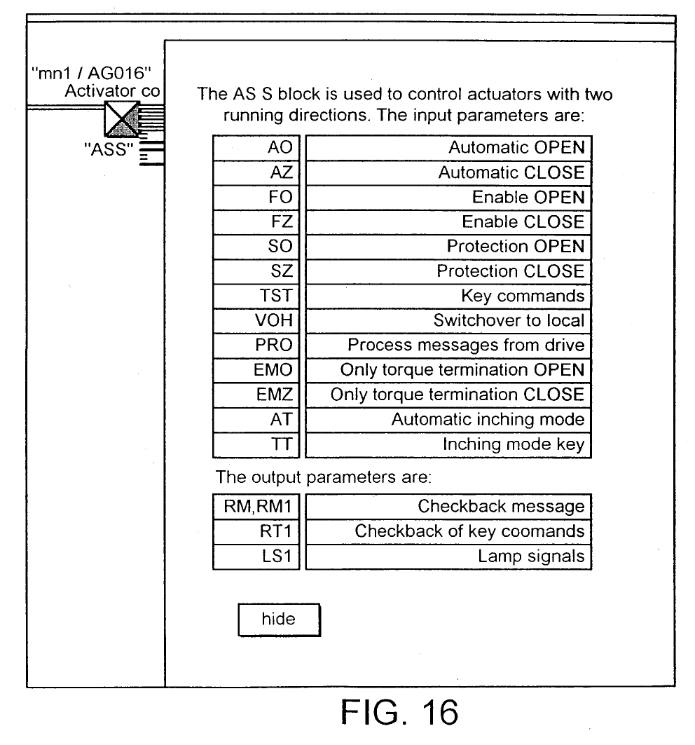

Item 3(a) is shown on the permanently displayed diagram, as explained in connection with FIG. 5b above. Item 3(d) is shown in FIG. 16. Item 3(e) is permanently illustrated on the diagram by changing the right-hand quadrant of the block, as shown in FIG. 5f. Item 3(f) is shown to the user by the use of a dark spot in the centre of the block, as shown in the centre of block 440 in FIG. 5f. Finally, item 3(g) is shown permanently by changing the colour of the top or bottom segments of a function block.

(4) Network Inputs

(a) the tag name and descriptor;

(b) a table of information about the network signal;

(c) the value of the network signal, and

(d) an indication that the system is able to trace the data further back towards its source, and selecting the indicator commences a trace action. In principle, all network inputs can be traced, even if to a plant input signal, but the system of the described embodiment is able to operate with partial information about the control system (DCS) and in that situation shows only what it is able to ascertain, with the remaining inputs not marked as traceable.

Item 4(a) is permanently shown on screen, as seen in FIG. 5d, for example. Item 4(b) is shown in FIG. 10 above. Item 4(d) is indicated by means of an arrow on a block, such as the arrow 430 in block 400 of FIG. 5d.

(5) Bit Selection Object

(a) The diagram permanently shows the bit number of the bit which a given object is selecting.

(6) Notes

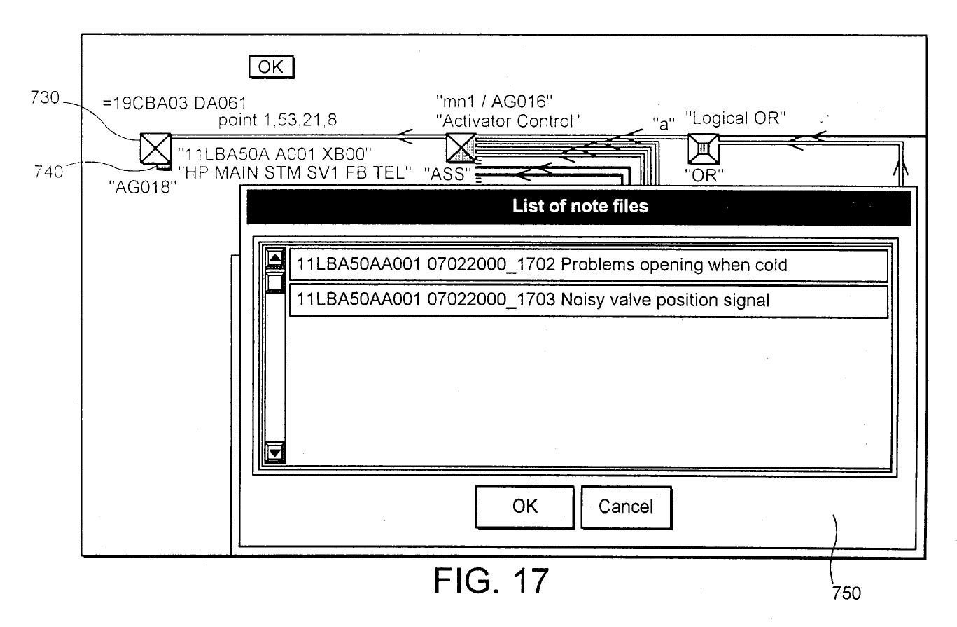

At any point in the diagram, the user may add notes to be associated with a particular block. This is shown in FIG. 17. Here, the block 730 (which represents a network output register of the high pressure main steam stop valve plant object) has a smaller block 740 beneath it. This smaller block indicates that at least one note exists for that plant object. A single mouse click on the block 740 opens up a further window 750 including in this case two note titles. The user may then click on these to read more detailed notes. The list of notes is automatically linked with all signals connected with the high pressure main steam stop valve.

Tracing the Cause of a Problem

One of the primary advantages of the system described herein is to permit rapid diagnosis of faults. This is achieved by the presentation of the logic in an order that relates to the problem at hand. Previously, fault tracing was a difficult and time-consuming process requiring the use of the limited information available on screen, cross-references to engineering drawings (usually, many pages of these), intuition and, particularly during execution of a sequence, occasionally luck.

Having read in all of the signals, and linked them by object orientation, the diagnosis of a fault may be achieved without having to resort to any of these approaches.

To explain the process for fault tracing, a specific example will now be provided. In a power station, it is unusual for all gas turbines to run all of the time; turbines are started and stopped according to a national or local demand for power. The starting-up of a gas turbine involves a large number of operations which must be carried out in sequence for successful start-up. This sequence may be shown diagrammatically; a part of the sequence has been described in connection with FIG. 9 above.

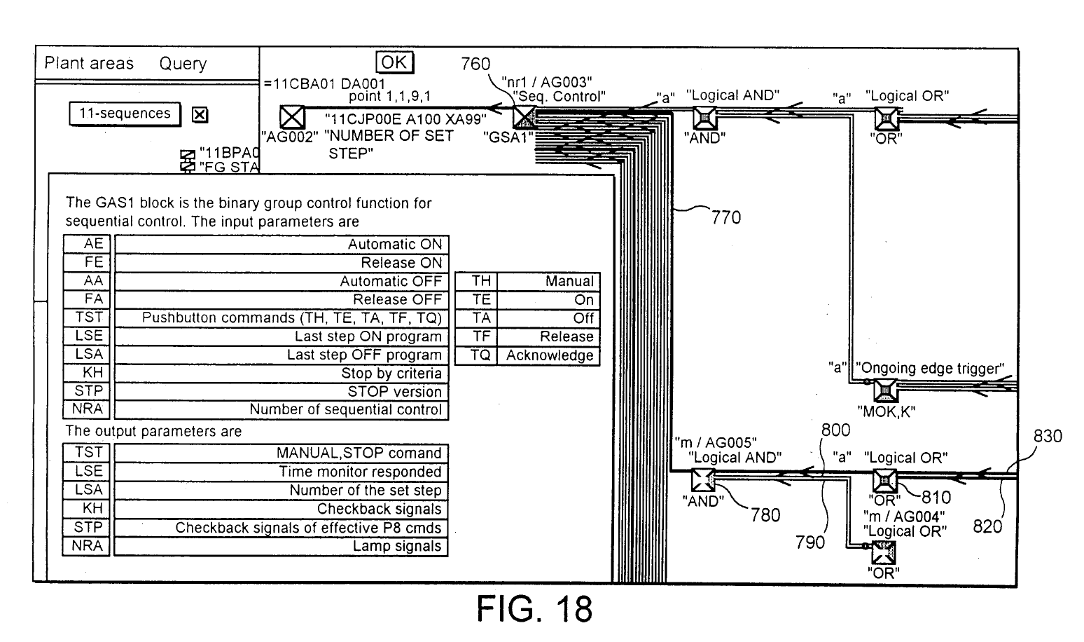

FIG. 18 shows a part of a start sequence that is co-ordinated by a block 760, labelled GSA1. This function block 760 receives a large number of input parameters, the first five of which give commands to the block 760, and the last five of which are concerned with identification of the block, and internal software co-ordination. In particular, the second input parameter (on line 770 in FIG. 18) is a release signal to allow the gas turbine to be started. Prior to starting the gas turbine, this must be asserted, and if it is not, the cause must be found.

As seen in FIG. 18, line 770 is not asserted, as indicated by its dark colour. Thus, the sequence fails to start. The operator inspects the GSA1 block 760 associated with the sequence (a menu choice from the sequence object), and reminds himself of the order of the parameters, noting that the release on signal (FE) indicated by line 770 is not made. Tracing backwards, the operator can immediately see that the signal comes from an AND block 780, which has one input (value true) shown by grey-coloured line 790, and one input (value false), indicated by dark line 800. The operator thus concludes that the problem must be with the latter, false valued input. Tracing backwards from block 780 along the line 800 (value false), he arrives at logic OR block 810 for which both inputs 820 and 830 are dark lines, i.e. false. This tells the operator that the problem could have arisen from either branch.

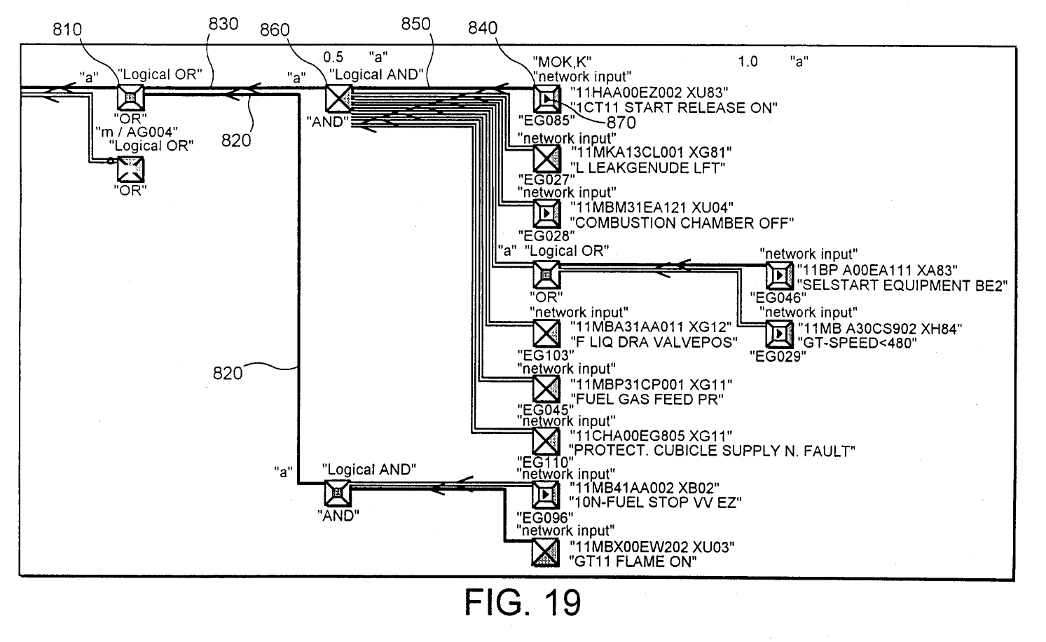

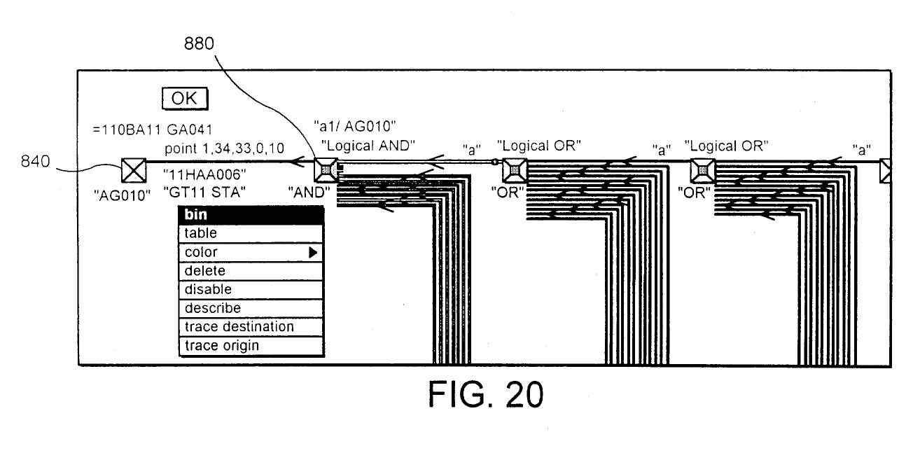

The operator scrolls the window to the right, to see the subsection below. This subsection is shown in FIG. 19. A quick inspection of the screen, shown in FIG. 19, indicates to the operator (provided that he is familiar with the process plant) that the lower branch 820 into the logic OR block 810 of FIG. 18 relates to restart of the sequence when the gas turbine is already running, and that the signals are exactly as expected for a shut-down plant. He therefore realizes that the problem must be with the upper branch 830, and in particular can be traced to the block 840, whose output is shown by a dark line 850 into a logic AND block 860. The block 840 is a network input block which is labelled GT11 Start Release ON. It is apparent that this is not being asserted.

Because the signal represented by block 840 comes from another input/output card on the network, it is necessary to click on the arrow in the centre of block 840, which immediately links to a separate diagram.

A part of the GT11 Start Release ON diagram is shown in FIG. 20. The full diagram contains 56 network inputs and 41 function blocks. They are organized into those signals that are required to be asserted, which are connected to the first AND block 880, and the larger number of signals that are required to be unasserted. A single problem will immediately stand out from the various signals indicated by the various lines into the logic blocks. In FIG. 20, the operator has selected the binary connection he is interested in, and has brought up its menu prior to selecting Trace Origin. This causes the diagram to be automatically repositioned to the source of the signal. Of course, manual repositioning could be carried out, but is slower.

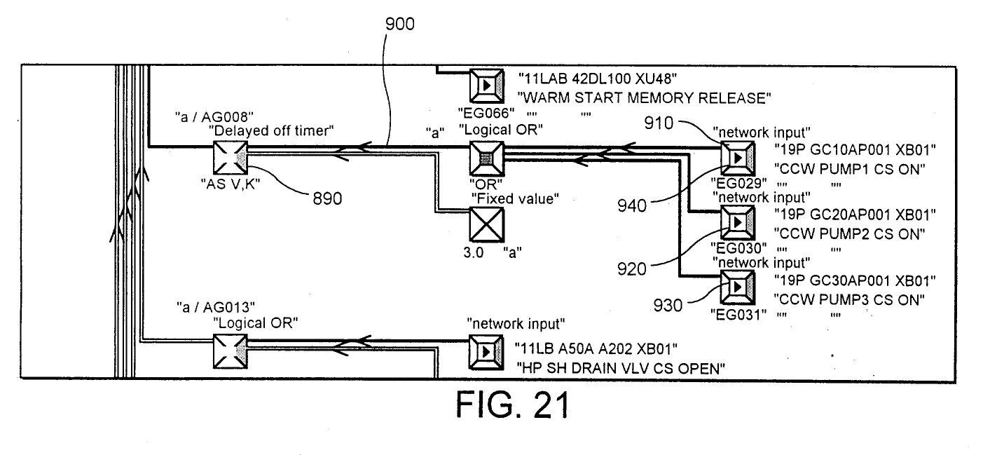

FIG. 21 shows the repositioned diagram. The source function block 890 is marked, to enable it to be picked out easily. The source is a Delayed Off Timer, with a time of three seconds, and an input 900 that is unasserted. It is clear that all of the inputs from the CCW pumps, represented by the three blocks 910, 920 and 930, are off. Seeing this, the operator will guess that, possibly, one of these three pumps was on, and that it has tripped.

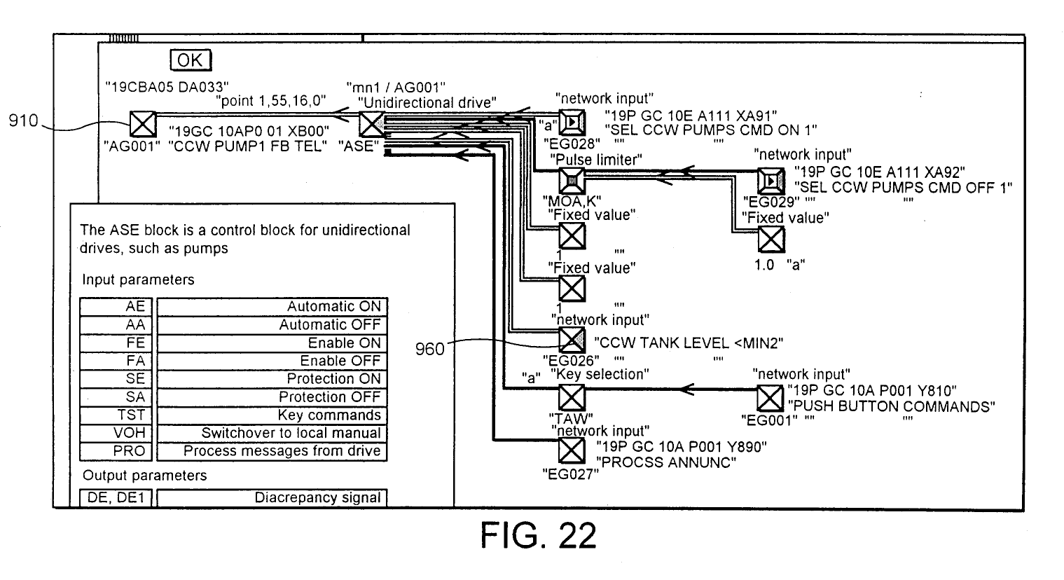

The operator therefore selects CCW pump 1 (represented by block 910), by clicking on the arrow 940 in the middle of the block 910. As shown in FIG. 22, in the present example, the operator decides that he needs to be reminded of the parameters of the function block that is its primary control. He sees that the Automatic ON signal is asserted (on line 950), but knows that the pump is not running. He then sees that the Protection OFF signal is asserted, and looks to see why. It comes from a tank level indication, indicated by block 960 and he notes (or already knows) that there is only one tank, and that it will affect all three CCW pumps.

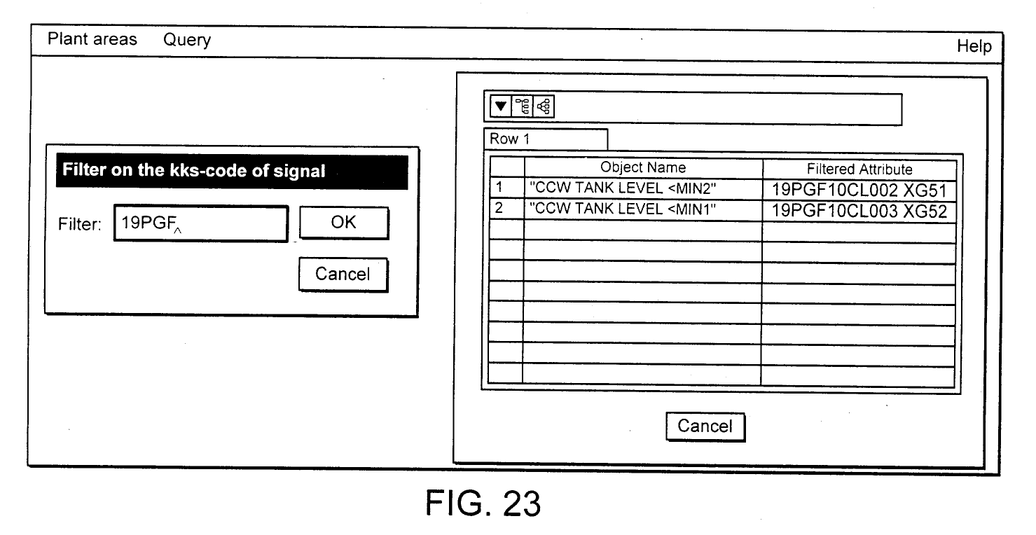

The operator carries out a query on plant item 19PGF (as represented by the block 960) to see if there is any more information about the tank, such as pumps, release valves etc., but finds that all the system has are two level limit switches, as shown in FIG. 23. These are most likely contacts operated mechanically in the tank. At this point, the operator realizes that is therefore necessary to send someone to the tank to check on the level and/or effect repairs.

The whole diagnostic process described above can be carried out in two to three minutes.

One technique for further accelerating the decision-making process is to mechanise some of the decoding of the logic. This is based upon the premise that generally a particular binary signal (at a particular time) is in the wrong state. This will typically be either a protection or permissive signal on a drive block, or an enable condition signal on a sequence step or sequence control block. It may, however, be any arbitrary signal. Each type of function block is then provided with a method by which it can determine which input or inputs is the most likely to be the cause of the output being in the undesired state. The relevant inputs are then traced back through their connections to further function blocks or network inputs. The results are then indicated by flashing the appropriate connections.

If it is considered desirable, the diagrams may be generated and used for the analysis, but not displayed, and the results may be indicated in a tabular manner, with likelihood estimators attached to various possible causes.

Whilst a number of embodiments of the invention have been described, it will be appreciated that these are not to be considered limiting. In particular, although the examples illustrate preferred implementations of the invention, they relate to a specific type of process plant (a power station), using a specific type of distributed control system. Therefore, the foregoing description is not to be considered limiting, the scope of the invention being determined with reference to the following claims.

1. A method of monitoring a control process in a process plant, the process plant comprising:
a plurality of plant items to be controlled, at least some of which have sensor means for obtaining a status signal indicative of the status of that plant item, and at least some of which have control means for controlling that plant item in response to a control signal; the method comprising
receiving a plurality of input signals, at least some of which have been derived from the said the status signals;
processing at least some of the input signals according to a control algorithm structured from a plurality of control functions, and generating a plurality of output signals from the processed input signals;
selecting a first output signal generated from an output of a one of the plurality of control functions of the control algorithm;
tracing the derivation of that first output signal to its source or sources via the said control algorithm, and
visually displaying the functional relationship between the source or sources and the first output signal which is a result of the control algorithm, so as to permit the tracing of a fault within the process plant from its effect back to its cause.

2. The method of claim 1, in which the step of visually displaying the functional relationship includes identifying the functional step or steps represented by a corresponding one or ones of the plurality of control functions within the control algorithm that link the source with the first output signal.

3. The method of claim 2, in which the step of identifying the functional steps is carried out recursively.

4. The method of claim 1 in which the said source is a first input signal from the process plant.

5. The method of claim 1 in which the said source is a predefined signal of fixed value or a limit value signal.

6. The method of claim 1 in which the said source is a signal specifiable by a user which defines a process plant control parameter.

7. The method of claim 6, in which the process plant control parameter is a set point for a process plant item.

8. The method of claim 1, in which the step of visually displaying the functional relationship comprises displaying the functional relationship between the source and the first output signal in a graphical format.

9. The method of claim 8, in which the graphical format is a tree structure, the branches of the tree representing links between one or more control functions in the said control algorithm.

10. The method of claim 9, in which the tree structure is built up using an Object Oriented programming language.

11. The method of claim 1, further comprising creating a data array of all of the input and output signals, and selecting the first output signal and the source from the data array.

12. The method of claim 11, in which the output signals in the data array are rankable in order of significance, the first output signal being selected from the data array in accordance with the significance thereof.

13. The method of claim 12, in which the first output signal is selected in accordance with a selection algorithm.

14. The method of claim 2, in which the first output signal has a plurality of ultimate sources, and in which there is a control function representing a single functional step between the said first output signal and the said plurality of sources, the functional step having a binary output in an incorrect binary state which is indicative of a fault, and a plurality of binary inputs at least one of which is also in an incorrect binary state thereby indicating a fault, the method further comprising identifying, for the functional step, the or each binary input which is in an incorrect binary state, the cause of the fault being determined to be the source or sources which provide the said binary input or inputs in the said incorrect binary state.

15. The method of any of claim 2, in which the first output signal has a plurality of ultimate sources, and in which there is at least one control function representing a plurality of functional steps between the said first output signal and at least some of the said plurality of sources, each functional step having a binary output in an incorrect binary state which is indicative of a fault, and a plurality of binary inputs at least one of which is also in an incorrect binary state thereby indicating a fault, the method further comprising:
identifying, for each functional step, the or each binary input which is in an incorrect state;
tracing backwards to one or more of the said plurality of sources by recursively identifying those binary inputs which are in an incorrect binary state; and
determining, on the basis of the said step of recursively identifying, the source or sources which are most likely to represent the root cause of the said fault.

16. The method of claim 1, in which the plant items are each connected to a central processor via a network.

17. The method of claim 1, in which the source includes live data derived from one or more status signals.

18. The method of claim 1, in which the source includes historic data previously obtained from one or more of the sensor means.

19. The method of claim 1, in which the control process comprises a series of steps to be carried out at different times, and in which there is both a functional and a temporal relationship between the source and the first output signal.

20. A computer program product comprising a plurality of program elements which cause a processor to execute the method steps of claim 1.

21. A computer storage medium upon which is stored the program product of claim 20.

22. An electromagnetic signal when carrying the program product of claim 20.

23. A system for monitoring a control process in a process plant, the process plant comprising:
a plurality of plant items to be controlled, at least some of which have sensor means for obtaining a status signal indicative of the status of that plant item, and at least some of which have control means for controlling that plant item in response to a control signal,
the system comprising: storage means for receiving a plurality of input signals at least some of which have been derived from the said status signals;
processor means for processing at least some of the input signals according to a control algorithm structured from a plurality of control functions, and for generating a plurality of output signals from the processed input signals; and
display means;
the processor means being further arranged to permit selection of a first output signal generated from an output of one of the plurality of control functions of the control algorithm, and to trace the derivation of that first output signal to its source or sources via the said control algorithm, the display means being arranged to display the functional relationship between the source or sources and the first output signal which is a result of the control algorithm, so as to permit the tracing of a fault within the process plant from its effect back to its cause.

24. The system of claim 22, in which the processor means is arranged to identify the functional step or steps represented by a corresponding one or ones of the plurality of control functions within the control algorithm that link the source with the first output signal.

25. The system of claim 23, in which the display means is a computer visual display unit (VDU) arranged to display the functional relationship between the source and the first output signal in a graphical format.

26. The system of claim 23, in which the storage means includes a database with which the processor means is capable of communication, the database being arranged to store a data array of all of the input and output signals, the processor means being further arranged to select the first output signal and the source from the data array.

27. A process plant comprising a plurality of plant items to be controlled, at least some of which have sensor means for obtaining a status signal indicative of the status of that plant item, and at least some of which have control means for controlling that plant item in response to a control signal, the plant items being connected via a network to the system of claim 23.
